(19) United States
(12) Patent Application Publication
(10) Pub. No.: US 2017/0132549 A1
(43) Pub. Date: May 11, 2017

(54) AUTOMATED INFORMATION TECHNOLOGY RESOURCE SYSTEM

(71) Applicant: INTERNATIONAL BUSINESS MACHINES CORPORATION, ARMONK, NY (US)

(72) Inventors: RAPHAEL EZRY, NEW YORK, NY (US); MUNISH GOYAL, ARMONK, NY (US); SANJAY K. PRASAD, BANGALORE (IN); SREEJIT ROY, KOLKATA (IN)

(21) Appl. No.: 14/937,005

(22) Filed: Nov. 10, 2015

(51) Int. Cl. G06Q 10/06

(52) U.S. Cl. CPC G06Q 10/06315

(57) ABSTRACT

Selected resources that satisfy a specified technical requirement are entered into a selected pool as a function of a sourcing rate, a screening rate and a selection rate that are each variable over time and applied during a sequence of selection time periods that span a demand forecast time period. Offers for acquisition are iteratively made to the selected pool of resources in a sequence of different offer time periods, wherein the resources are progressively moved into different awaiting offer buffers after each of the offer time periods. The demand number is re-forecast and one or more of the sourcing, screening and selection rates adjusted to minimize a combination of costs of the rates with a cost of acquiring resources to satisfy the gap number as a function of the demand number.

### BACKGROUND

Information Technology (IT) organizations must manage resources to meet dynamic and changing demands and requirements. Existing and available resources may have a variety of diverse and fragmented technical capacities, each having supply and demand characteristics that are specific as to technical domain, geographic location, and timeframes. It is difficult to accurately match resources to current and projected future needs in view of dynamic and changing IT environments created by the regular introduction of new programming languages and operating systems and application creation, maintenance, security requirements and service level agreement conditions. Thus, effectively managing IT resource costs is complex and challenging

### SUMMARY

In one aspect of the present invention, a method includes a processor forecasting a demand number for resources that meet a specified technical requirement from demand inputs as a function of time, for a demand forecast time period into the future. A selected number of resources that satisfy the specified technical requirement are entered set into a selected pool as a function of a sourcing rate, a screening rate and a selection rate that are each variable over time and applied during a sequence of selection time periods that span the demand forecast time period. Offers for acquisition are iteratively made to resources in the selected pool for each of a sequence of different offer time periods, and wherein the resources are progressively moved in the selected pool into one each of a plurality of different awaiting offer buffers at ends of each of the different offer time periods, in respective numbers that are determined to minimize gap number differences between a number of accepted offers from the selected resources and the determined demand number during each of the different offer time periods. In response to determining that the determined demand number is not met by the numbers of accepted offers from the selected resources, the demand number is re-forecast and one or more of the sourcing rate, the screening rate and the selection rate are adjusted to minimize a combination of costs of the sourcing, screening and selection rates with of acquiring resources to satisfy the gap number determined as a function of the re-forecast demand number. Thus, another set of selected number of resources that satisfy the specified technical requirement are entered into the selected pool for presentment of acquisition offers as a function of the re-forecast demand number and adjusted sourcing, screening or selection rate.

In another aspect, a system has a hardware processor in circuit communication with a computer readable memory and a computer-readable storage medium having program instructions stored thereon. The processor executes the program instructions stored on the computer-readable storage medium via the computer readable memory and thereby forecasts a demand number for resources that meet a specified technical requirement from demand inputs as a function of time, for a demand forecast time period into the future. A selected number of resources that satisfy the specified technical requirement are entered set into a selected pool as a function of a sourcing rate, a screening rate and a selection rate that are each variable over time and applied during a sequence of selection time periods that span the demand forecast time period. Offers for acquisition are iteratively made to resources in the selected pool for each of a sequence of different offer time periods, and wherein the resources are progressively moved in the selected pool into one each of a plurality of different awaiting offer buffers at ends of each of the different offer time periods, in respective numbers that are determined to minimize gap number differences between a number of accepted offers from the selected resources and the determined demand number during each of the different offer time periods. In response to determining that the determined demand number is not met by the numbers of accepted offers from the selected resources, the demand number is re-forecast and one or more of the sourcing rate, the screening rate and the selection rate are adjusted to minimize a combination of costs of the sourcing, screening and selection rates with of acquiring resources to satisfy the gap number determined as a function of the re-forecast demand number. Thus, another set of selected number of resources that satisfy the specified technical requirement are entered into the selected pool for presentment of acquisition offers as a function of the re-forecast demand number and adjusted sourcing, screening or selection rate.

In another aspect, a computer program product has a computer-readable storage medium with computer readable program code embodied therewith. The computer readable program code includes instructions for execution which cause the processor to forecast a demand number for resources that meet a specified technical requirement from demand inputs as a function of time, for a demand forecast time period into the future. A selected number of resources that satisfy the specified technical requirement are entered set into a selected pool as a function of a sourcing rate, a screening rate and a selection rate that are each variable over time and applied during a sequence of selection time periods that span the demand forecast time period. Offers for acquisition are iteratively made to resources in the selected pool for each of a sequence of different offer time periods, and wherein the resources are progressively moved in the selected pool into one each of a plurality of different awaiting offer buffers at ends of each of the different offer time periods, in respective numbers that are determined to minimize gap number differences between a number of accepted offers from the selected resources and the determined demand number during each of the different offer time periods. In response to determining that the determined demand number is not met by the numbers of accepted offers from the selected resources, the demand number is re-forecast and one or more of the sourcing rate, the screening rate and the selection rate are adjusted to minimize a combination of costs of the sourcing, screening and selection rates with of acquiring resources to satisfy the gap number determined as a function of the re-forecast demand number. Thus, another set of selected number of resources that satisfy the specified technical requirement are entered into the selected pool for presentment of acquisition offers as a function of the re-forecast demand number and adjusted sourcing, screening or selection rate.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts a computerized aspect according to an embodiment of the present invention.

FIG. 4 is a flow chart illustration of a method or process according to an embodiment of the present invention.

FIG. 5 is a flow chart illustration of another embodiment according to the embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

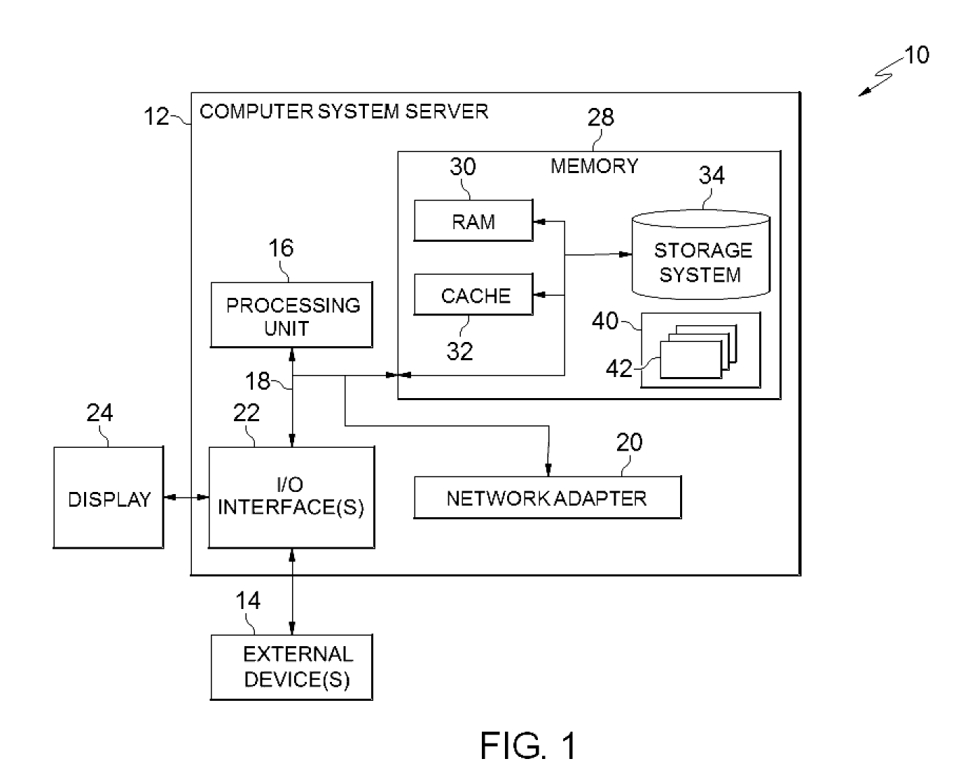

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

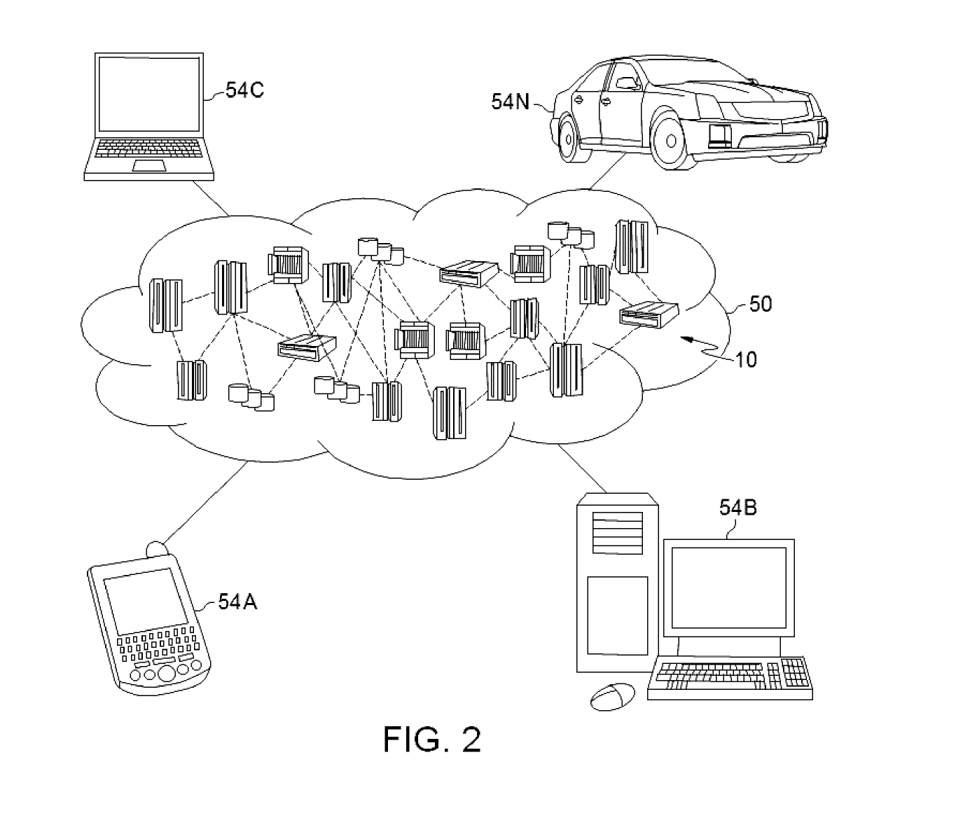

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing 96 for pooling amounts of talent as a function of skill demand and cost, as described below.

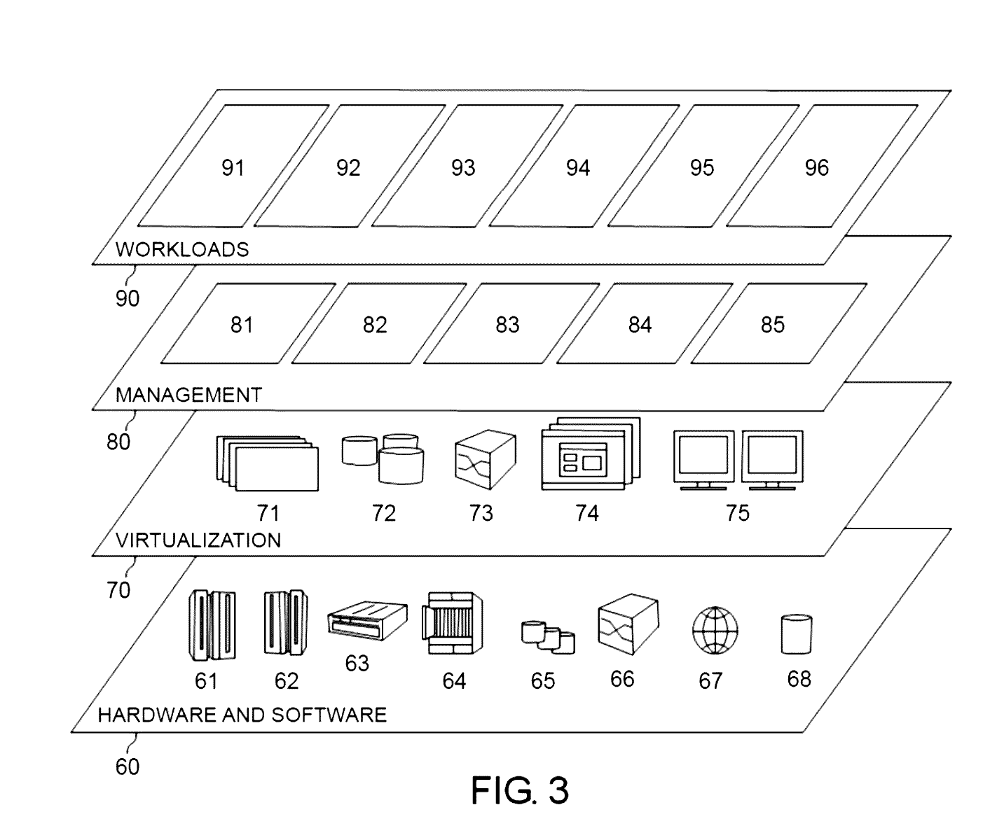

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Hiring client requirements may comprehend diverse and fragmented skill units, with demand and supply characteristics that are skill-specific, location-specific and time-dependent. Variable values that effect RPO systems include demand lead time (LT) and volatility metrics, which may vary significantly across stock-keeping units (SKU's). Forecast accuracy may be low, due to unpredictable demand. Supply LT & predictability may also vary significantly and unpredictably. Rates of availability (supply) and leakage (attrition) from candidate pools (or buffers) and conversion ratios (from buffered candidate pool to hired candidates) may vary depending on skill, location, experience requirements and market competition. Supply accuracy (plan versus actual) may be low, and vary by skill and source metrics. Demand withdrawals may be highly variable, and urgent demands may significantly impact plans across SKU's or other client accounts. Costs associated with delayed fulfillment by also be significant, and variable pursuant to agreement terms.

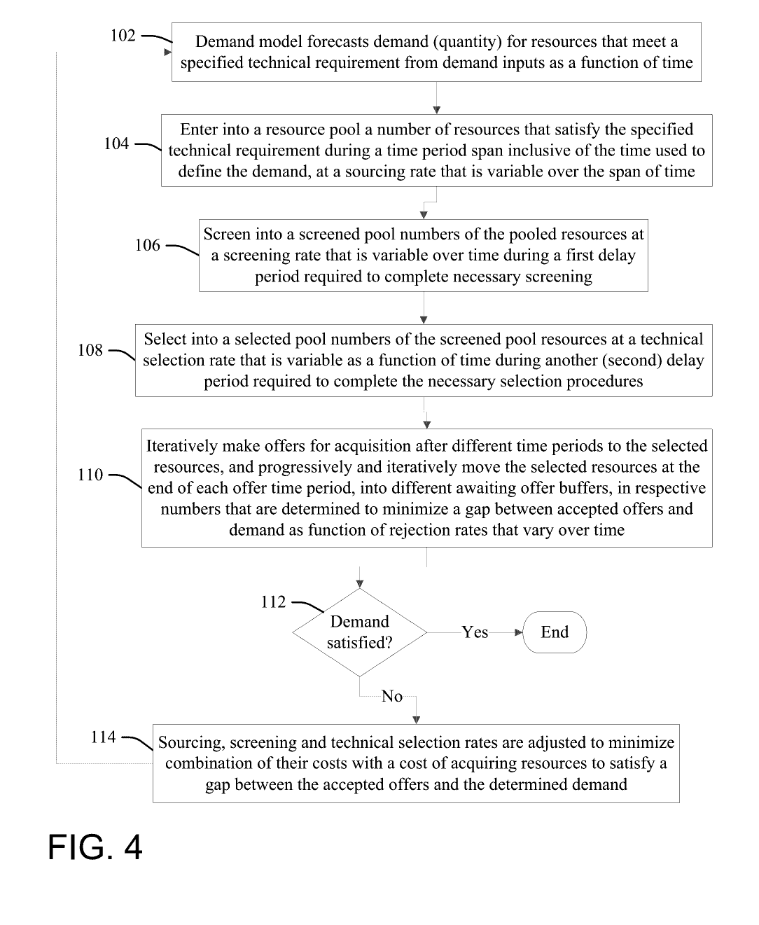

FIG. 4 (or “FIG. 4”) illustrates a computer implemented method or process of an aspect of the present invention for pooling amounts of resources as a function of meeting specified technical requirements (for example, skill, demand, cost, etc.). A processor (for example, a central processing unit (CPU)) executes code, such as code installed on a storage device in communication with the processor, and thereby performs the following process step elements illustrated in FIG. 4.

A demand model at 102, forecasts numbers of open, unfilled job positions for resources that meet a specified technical requirement (“r”) from demand inputs as a function of time (“t”), including for a forecast time period into the future (“t+k,” where “k” is used to designate a period of time, or time of delay, beyond the current time “t”), and wherein the demand determination process which may be accordingly denoted by “Demand(t+k)”. The demand may also be quantified at 102 as a proportion of a number of open, unfilled positions for resources that satisfy a specified technical requirement, relative to a number of resources available to fill said positions, and still other metrics may be practiced. The time period “t+k” may be any specified period of interest that is relevant to resource sourcing, and illustrative but not limiting or exhaustive examples include a week, a fortnight (two weeks), a month, and a quarter of a year, and still others will be apparent to one skilled in the art.

In one aspect, the demand model at 102 is a Brownian motion model with drift that generates an objective demand output in a continuous-time stochastic (or random) process, generating random values that quantify the variability in demand in the job market for candidates having the skill set “r” over time, as a function of drift (the change of the average value of the demand value generated by the model the process, or drift rate.) Other demand models that vary outputs as a function of time may be practiced in other embodiments, and illustrative but not limiting or exhaustive examples include Simple Moving Average (MA), Weighted Moving Average (WMA) and Basic Exponential Smoothing (BES).

Inputs to the demand model include historic demand metrics as well as top skill identification signals determined from social media analysis, core skill analysis signals that classify base skill sets and identify related skill groupings using proximity graphs, sentiment scores determined from market sentiment mining, site influence adjustment factors that attach influence scores and weights to data sources, and still other appropriate input data and factors will be apparent to one skilled in the art.

At 104 numbers of resources that satisfy the specified technical requirements “r” are entered (sourced) over time into a resource pool or buffer (“Xᵣ(t)”) during a first time period span (“TimePeriod”) that is inclusive of the time period “k” used to define the forecast demand number, at a resource sourcing rate that is variable over the span of time (“αᵣ(t+k)”), according to the following process [1]:

Xᵣ(t+k+1)=αᵣ(t+k)*TimePeriod [1]

Both the demand and the rate of sourcing may vary over the time period “t+k,” as a function of changing market demands, impact of the number of resources already in pool on rate of acceptance of extended acquisition offers, other resources entering the market or leaving the market during each time period, etc.

At 106 a number of the pooled resources that meet screening requirements are screened and moved over time from the resource pool into a screened pool (“Yᵣ(t)”) at a screening rate that is variable over time (“βᵣ(t)”), and during a second (first delay) time period that is required to complete the necessary screening procedures to advance such pooled candidates to screened status (“Delay1”), according to the following process [2]:

Yᵣ(t+k+1)=Xᵣ(t+k−Delay1)*βᵣ(t+k−Delay1) [2]

The rate of screening (“βᵣ(t)”) may vary over time as a function of impact from resources leaving the sourcing pool while awaiting screening, during the time necessary to verify and short-list most desired resources, etc.

At 108 a number of the resources in the screened pool are selected and moved from the screened pool into a selected pool (“Zᵣ(t)”) at a technical selection rate that is variable as a function of time (“Yᵣ(t)”) during another (second) delay period that is subsequent to the first delay period and is required to complete the necessary selection procedures to advance the screened resources to selected status (“Delay2”), according to the following process [3]:

Zᵣ(t+k+1)=Yᵣ(t+k−Delay2)*Yᵣ(t+k−Delay2) [3]

Said rate of selection of screened resources for presentment of offers of acquisition (Zᵣ(t)) may also vary over time as a function of impact from resources leaving the screened pool while awaiting offers to accept other competing acquisition offers, during time periods necessary to short-list the resources and complete review processes and assess review results, etc.

At 110 a plurality of offers for acquisition are iteratively made after different time periods (“k”) to the selected resources, and the selected resources progressively and iteratively moved at the end of each offer time period, into different awaiting offer buffers, in respective numbers that are determined to minimize a gap between numbers of accepted offers and the determined demand (“Gap(t)”) as function of rejection rates that vary over time (“Rᵣ(t)”).

At 112, the process determines if the demand has been met by accepted offers from the buffered resources. If not, then at 114 the resource sourcing rate (αᵣ(t+k)), resource screening rate (βᵣ(t)) and resource technical selection rate (Yᵣ(t)) are adjusted to minimize their costs in combination with a cost of acquiring resources (“(ωᵣ(t+k)”) to satisfy the gap between the accepted offers and the determined demand (“Gap(t)”), according to the following minimize process [4]:

Min[Σₖωᵣ(t+k)*Gap(t+k)+Cost(αᵣ(t+k),βᵣ(t+k),Yᵣ(t+k))] [4]

The cost of acquiring resources (ωᵣ(t)) is generally the cost born due to vacancies unfilled by the resources sourced into the aspects of the present invention. For example, if a client cannot complete a project offering a given amount of profit margin due to a shortage of a resource, then the cost of the gap may be defined by the amount of the lost profit margin on said project. Still other mechanisms for quantifying gap costs will be apparent to one skilled in the art.

The costs of the different resource sourcing rate (αᵣ(t+k)), resource screening rate (βᵣ(t)) and resource technical selection rate (Yᵣ(t)) may reflect costs in accelerating (or slowing) said rates, for example via hiring or allocating additional manpower or processing power resources to the associated tasks in order to increase their rates, or in saving money by using less of said resources and allowing the rates to slow.

Thus, the process repeats at 102 by utilizing the resource sourcing rate (αᵣ(t+k)), resource screening rate (βᵣ(t)) and resource technical selection rate (Yᵣ(t)) as adjusted at 114.

Aspects of the present invention may revise the forecast and re-forecast demand numbers of open, unfilled job positions for resources that meet a specified technical requirement from the demand inputs during the respective time periods of each of the process steps 104 through 114, thereby dynamically responding to changes in demand during each of said process steps.

Some aspects of the present invention pool amounts of IT talent as a function of skill demand and cost. Thus, with respect to the process described above and illustrated in FIG. 4, in one embodiment the demand number forecast (at 102) for resources that meet a specified technical requirement is a number of open job positions for candidates having a specified skill, the resources entered into the selected pool is a selected number of candidates that satisfy requirements for the specified skill set, the offers for acquisition (at 110) are offers of embodiment to the candidates, and the cost of acquiring resources to satisfy the gap number is a cost to hiring clients to hire the candidates that accept the offers of employment.

Such aspects may proactively manage the talent supply chain in response to anticipated changes in the market conditions while minimizing costs, improving hiring lead times and quality of pooled candidates. Parameters within the process may be optimized for a given objective (cost, demand, gap, etc.), as a function of lead time or any other time period. The cost and overall quality of the results are improved by recognizing determined and forecast (expected) gaps in supply and demand of candidates, and the costs of such gaps, and adjusting candidate buffer sizes accordingly. As and when suitable demand arises from a client, suitable skilled candidates from the buffers may be efficiently referred to a client for offer and on-boarding.

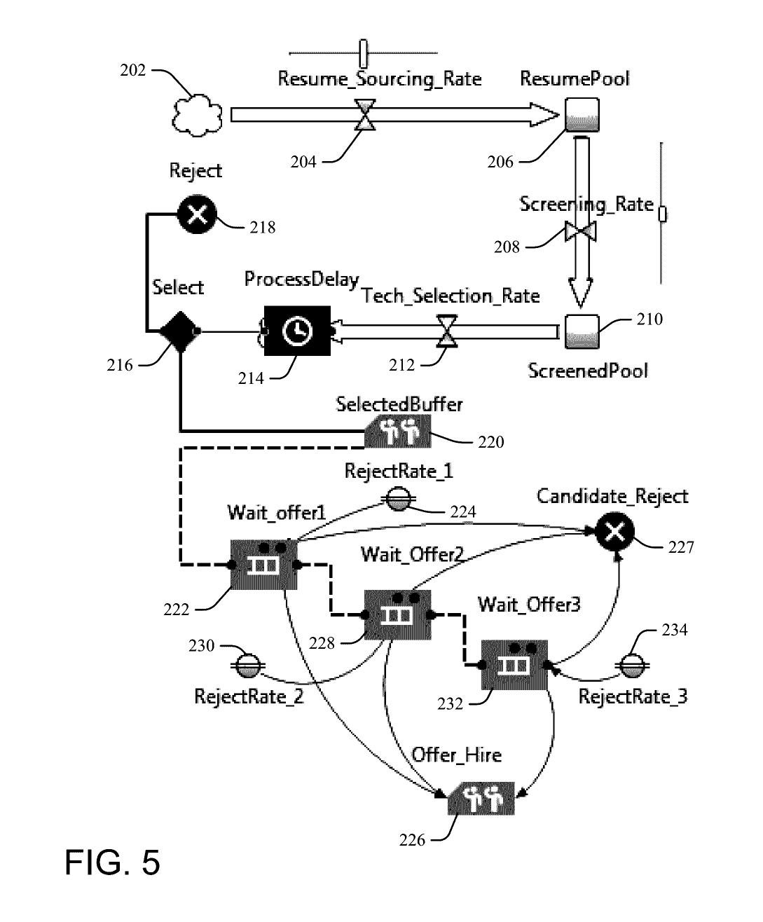

FIG. 5 illustrates one example of the process of FIG. 4 that is deployed in the projecting and meeting demands for candidate resources that meet specified technical requirements. As a function of a forecast demand amount 202 for specified skill set “r” (determined by the demand model at 102, FIG. 4), a number of candidates (Xᵣ(t)) that satisfy the skill set requirements is brought into a Resume Pool 206 (resource pool) at the resume sourcing rate (αᵣ(t+k)) 204, according to step 104, FIG. 4.

A number of the pooled resume candidates (Yᵣ(t)) are screened over, at the resume screening rate (βᵣ(t)) 208, into a Screened Pool 210, and during the first delay period required to complete the necessary screening procedures to advance the pooled candidates to screened status (“Delay1”) (see the process at 106, FIG. 4).

The candidates in the screened pool 210 move to a “Process delay” buffer 214, wherein at 216 they are either rejected (and discarded) at 218, or selected into the selected buffer 220, at the variable resume technical selection rate (Yᵣ(t)) 212, and wherein the total number of selected candidates moved into the selected buffer 220 is defined by (Zᵣ(t)) (see step 108 of FIG. 4).

The selected buffer 220 comprises three different awaiting-offer buffers, Wait_offer1 222, Wait_offer2 228 and Wait_offer3 232. As described generally at 110 of FIG. 4, a plurality of offers for employment are iteratively made after different time periods to the selected candidates, and the selected candidates progressively and iteratively moved at the end of each offer time period, from Wait_offer1 222 to Wait_offer2 228, and from Wait_offer2 228 to Wait_offer3 232, in respective numbers that are determined to minimize a gap between numbers of accepted offers and the determined demand (“Gap(t)”) as function of rejection rates that vary over time (“Rᵣ(t)”).

Each of the different wait offer buffers 222, 228 and 232 have different, respective rates of rejection 224, 230 and 234 for pending offers presented to the candidates while they are residing in the respective buffers 222, 228 and 232, which are determined differentially as a function of labor market parameters and the different times that the client finds themselves in one of the buffers 222, 228 and 232.

Thus, first offers for employment are made to one or more of the selected candidates within the selected buffer 220, and the selected candidates (“W¹ᵣ(t)”) are moved into the first awaiting-offer buffer (Wait_offer1 222) during the pendency of the offers, wherein W¹ᵣ (t+k+1)=Zᵣ(t+k+1)). Said offers are rejected during the period “k,” and the candidates discarded from the first wait buffer 222 at 227 at a first rate of rejection (R¹ᵣ(t), or RejectRate_1 224) that is determined as a function of labor market parameters and time. Candidates that accept offers are moved to the Offer_Hire buffer 226 and thereby also removed from the first wait buffer 222.

The gap (“Gap(t+k)”) determined at 112 of FIG. 4 between the current demand (Demand(t+k)) and the positions filled by acceptance of the offers presented and rejected at the first rate of rejection (R¹ᵣ(t), or RejectRate_1 224) is used to predict or determine the number of candidates (W²ᵣ(t)) remaining with the first wait buffer 222 that move into the second awaiting-offer buffer (“Wait_offer2 228), according to the following process [5]:

W²ᵣ(t+k+1)=min([W¹ᵣ(t+k)+W²ᵣ(t+k)+W³ᵣ(t+k)−Gap(t+k−1)−Demand(t+k)]⁺,

,W¹ᵣ(t+k−1))*(1−R¹ᵣ(t+k) [5]

The notation “[ ]⁺” within the processes described herein indicates that the value within the brackets cannot be less than zero, maximum value (value, 0).

The gap (“Gap(t+k)”) is also used to predict or determine the number of candidates (W³ᵣ(t)) remaining with the second wait buffer 228 (after other accept offers and move into the offer_hire buffer 226, or reject offers at the second wait buffer rate of rejection (R²ᵣ(t), or RejectRate_2 230) that move into the third awaiting-offer buffer (“Wait_offer3 232), according to the following process [6]:

W³ᵣ(t+k+1)=min([W³ᵣ(t+k)−Gap(t+k−1)−Demand(t+k)]⁺,W³ᵣ(t+k−1))*(1−R³ᵣ(t+k)))

+min([W²ᵣ(t+k)+W³ᵣ(t+k)−Gap(t+k−1)−Demand(t+k)]⁺,

W²ᵣ(t+k−1))*(1−R²ᵣ(t+k) [6]

In the example shown in FIG. 5, the step (at 114, FIG. 4) of adjusting the resume sourcing rate (αᵣ(t+k)), resume screening rate (βᵣ(t)) and resume technical selection rate (Yᵣ(t)) to minimize their costs in combination with the cost to hiring clients (“(ωᵣ(t+k)”) of the gap between the accepted offers and the determined demand (“Gap(t)”), is further subject to the sum of the buffer sizes (number of waiting candidates) within each of “i” wait buffers, according to the following process [7]:

Gap(t+k)=[Gap(t+k−1)+Demand(t+k)−ΣWⁱᵣ(t+k)]⁺ [7]

In some aspects, the selected candidates are iteratively and progressively moved to each of the different awaiting offer buffers at the end of each of “k” time periods, resulting in “k” awaiting offer buffers that each have different, respective rejection rates.

In one illustrative but not limiting or exhaustive example the rejection rates increase with an increasing total wait period experience by the candidate from the initial selection, and therefore R¹ᵣ(t)<R²ᵣ(t)<R³ᵣ(t). In one example R¹ᵣ(t)=10%, R²ᵣ(t)=25% and R³ᵣ(t)=40%. The relative numbers within each of the awaiting buffers also diminishes over time, reflecting that some of the selected candidates may leave the buffer by accepting other offers, which may be modeled into the different respective rejection rates for each of the awaiting offer buffers, thereby progressively modeling the depletion of total numbers of selected candidate awaiting offers buffers within each of the buffers over time.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising executing on a computer processor the steps of:
forecasting a demand number for resources that meet a specified technical requirement from demand inputs as a function of time, for a demand forecast time period into the future;
entering a selected number of resources that satisfy the specified technical requirement into a selected pool as a function of a sourcing rate, a screening rate and a selection rate that are each variable over time and applied during a sequence of selection time periods that span the demand forecast time period;
iteratively making offers for acquisition for each of a sequence of different offer time periods to the resources in the selected pool, and progressively moving the resources in the selected pool into one each of a plurality of different awaiting offer buffers at ends of each of the different offer time periods, in respective numbers that are determined to minimize gap number differences between a number of accepted offers from the selected resources and the determined demand number during each of the different offer time periods; and
in response to determining that the determined demand number is not met by the numbers of accepted offers from the selected resources, re-forecasting the demand number and adjusting at least one of the sourcing rate, the screening rate and the selection rate to minimize a combination of costs of said sourcing rate, screening rate and selection rate with a cost of acquiring resources to satisfy the gap number that is determined as a function of the re-forecast demand number, and entering another set of a selected number of resources that meet the specified technical requirement into the selected pool for presentment of offers for acquisition as a function of the re-forecast demand number and the at least one adjusted sourcing rate, screening rate and selection rate.

2. The method of claim 1, further comprising:
integrating computer-readable program code into a computer system comprising the processor, a computer readable memory in circuit communication with the processor, and a computer readable storage medium in circuit communication with the processor; and
wherein the processor executes program code instructions stored on the computer-readable storage medium via the computer readable memory and thereby performs the steps of forecasting the demand number for resources that meet the specified technical requirement, entering the selected number of resources that satisfy the specified technical requirement into the selected pool as the function of the sourcing rate, the screening rate and the selection rate, iteratively making the offers for acquisition for each of the sequence of different offer time periods to the resources in the selected pool, progressively moving the resources in the selected pool into the one each of the plurality of different awaiting offer buffers and, in response to determining that the determined demand is not met by the numbers of accepted offers from the selected resources, re-forecasting the demand number and adjusting the at least one of the sourcing rate, the screening rate and the selection rate to minimize the combination of costs of said sourcing rate, screening rate and selection rate with the cost of acquiring resources to satisfy the gap number determined as a function of the re-forecast demand number, and entering another set of a selected number of resources that meet the specified technical requirement into the selected pool for presentment of acquisition offers as the function of the re-forecast demand number and the at least one adjusted sourcing rate, screening rate and selection rate.

3. The method of claim 1, wherein the step of entering the selected number of resources that meet the specified technical requirement into the selected pool comprises:
entering a first number of the resources into a resource pool at the sourcing rate that is variable over time during a first time period span that is inclusive of the demand forecast time period;
moving a second number of the resources that satisfy screening requirements from the resource pool into a screened pool at the screening rate that is variable over time during a second time period span that is subsequent to the first time period and inclusive of the demand forecast time period; and
moving a third number of the resources that satisfy selection requirements from the screened pool into a selected pool at the selection rate that is variable over time during a third time period span that is subsequent to the second time period and inclusive of the demand forecast time period.

4. The method of claim 3, wherein the steps of forecasting and re-forecasting the demand number comprises using a Brownian motion model with drift to generate random values that quantify variability in demand for resources that meet the specified technical requirement in a continuous-time stochastic process as a function of a drift rate of change in average values of the generated random values.

5. The method of claim 3, further comprising:
revising the forecast and re-forecast demand numbers for resources that meet the specified technical requirement from the demand inputs for respective time periods of each of the steps of entering the selected number of resources into the selected pool, iteratively making offers for acquisition for each of the sequence of different offer time periods, adjusting the at least one of the sourcing rate, the screening rate and the selection rate and entering the another set of selected number of resources that meet the specified technical requirement into the selected pool for presentment of acquisition offers as a function of the re-forecast demand number and the at least one adjusted sourcing rate, screening rate and selection rate.

6. The method of claim 3, wherein the plurality of different awaiting offer buffers are each associated with different, respective rates of rejection for pending offers presented to the resources while they are in the respective buffers, and which are determined differentially as a function of market parameters and the different times during which the resources reside in respective ones of the different awaiting offer buffers.

7. The method of claim 6, wherein the plurality of different awaiting offer buffers comprises a first awaiting offer buffer that is associated with a first of the different, respective rates of rejection for pending offers presented to the resources, a second awaiting offer buffer that is associated with a second of the different, respective rates of rejection for pending offers presented to the resources and that receives resources moved from the first awaiting offer buffer that have not rejected or accepted an offer for acquisition, and a third awaiting offer buffer that is associated with a third of the different, respective rates of rejection for pending offers presented to the resources and that receives resources moved from the second awaiting offer buffer that have not rejected or accepted an offer for acquisition; and
wherein the first rejection rate is less than the second rejection rate, and the second rejection rate is less than the third rejection rate.

8. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
forecasts a demand number for resources that meet a specified technical requirement from demand inputs as a function of time, for a demand forecast time period into the future;
enters a selected number of resources that satisfy the specified technical requirement into a selected pool as a function of a sourcing rate, a screening rate and a selection rate that are each variable over time and applied during a sequence of selection time periods that span the demand forecast time period;
iteratively makes offers for acquisition for each of a sequence of different offer time periods to the resources in the selected pool, and progressively moving the resources in the selected pool into one each of a plurality of different awaiting offer buffers at ends of each of the different offer time periods, in respective numbers that are determined to minimize gap number differences between a number of accepted offers from the selected resources and the determined demand number during each of the different offer time periods; and
in response to determining that the determined demand number is not met by the numbers of accepted offers from the selected resources, re-forecasts the demand number and adjusts at least one of the sourcing rate, the screening rate and the selection rate to minimize a combination of costs of said sourcing rate, screening rate and selection rate with a cost of acquiring resources to satisfy the gap number that is determined as a function of the re-forecast demand number, and enters another set of a selected number of resources that meet the specified technical requirement into the selected pool for presentment of offers for acquisition as a function of the re-forecast demand number and the at least one adjusted sourcing rate, screening rate and selection rate.

9. The system of claim 8, wherein the processor executes the program instructions stored on the computer-readable storage medium via the computer readable memory and thereby enters the selected number of resources that meet the specified technical requirement into the selected pool by:
entering a first number of the resources into a resource pool at the sourcing rate that is variable over time during a first time period span that is inclusive of the demand forecast time period;
moving a second number of the resources that satisfy screening requirements from the resource pool into a screened pool at the screening rate that is variable over time during a second time period span that is subsequent to the first time period and inclusive of the demand forecast time period; and
moving a third number of the resources that satisfy selection requirements from the screened pool into a selected pool at the selection rate that is variable over time during a third time period span that is subsequent to the second time period and inclusive of the demand forecast time period.

10. The system of claim 9, wherein the processor executes the program instructions stored on the computer-readable storage medium via the computer readable memory and thereby forecasts and re-forecasts the demand number by using a Brownian motion model with drift to generate random values that quantify in demand for resources that meet the specified technical requirement in a continuous-time stochastic process as a function of a drift rate of change in average values of the generated random values.

11. The system of claim 9, wherein the processor executes the program instructions stored on the computer-readable storage medium via the computer readable memory and thereby revises the forecast and re-forecast demand numbers for resources that meet the specified technical requirement from the demand inputs during for respective time periods of each of processes of the entry of the selected number of resources into the selected pool, the iterative offers for acquisition for each of the sequence of different offer time periods, the adjustment of the at least one of the sourcing rate, the screening rate and the selection rate and entry of the another set of selected number of resources that meet the specified technical requirement into the selected pool for presentment of acquisition offers as a function of the re-forecast demand number and the at least one adjusted sourcing rate, screening rate and selection rate.

12. The system of claim 9, wherein the plurality of different awaiting offer buffers are each associated with different, respective rates of rejection for pending offers presented to the resources while they are in the respective buffers, and that are determined differentially by the processor as a function of market parameters and the different times during which the resources reside in respective ones of the different awaiting offer buffers.

13. The system of claim 12, wherein the plurality of different awaiting offer buffers comprises a first awaiting offer buffer that is associated with a first of the different, respective rates of rejection for pending offers presented to the resources, a second awaiting offer buffer that is associated with a second of the different, respective rates of rejection for pending offers presented to the resources and that receives resources moved by the processor from the first awaiting offer buffer that have not rejected or accepted an offer for acquisition, and a third awaiting offer buffer that is associated with a third of the different, respective rates of rejection for pending offers presented to the resources and that receives resources moved by the processor from the second awaiting offer buffer that have not rejected or accepted an offer for acquisition; and
wherein the first rejection rate is less than the second rejection rate, and the second rejection rate is less than the third rejection rate.

14. The system of claim 13, wherein the program instructions stored on the computer-readable storage medium are provided as a service in a cloud environment.

15. A computer program product comprising:
a computer readable storage medium having computer readable program code embodied therewith, wherein the computer readable storage medium is not a transitory signal per se, the computer readable program code comprising instructions for execution by a processor that cause the processor to:
forecast a demand number for resources that meet a specified technical requirement from demand inputs as a function of time, for a demand forecast time period into the future;
enter a selected number of resources that satisfy the specified technical requirement into a selected pool as a function of a sourcing rate, a screening rate and a selection rate that are each variable over time and applied during a sequence of selection time periods that span the demand forecast time period;
iteratively make offers for acquisition for each of a sequence of different offer time periods to the resources in the selected pool, and progressively move the resources in the selected pool into one each of a plurality of different awaiting offer buffers at ends of each of the different offer time periods, in respective numbers that are determined to minimize gap number differences between a number of accepted offers from the selected resources and the determined demand number during each of the different offer time periods; and
in response to determining that the determined demand number is not met by the numbers of accepted offers from the selected resources, re-forecast the demand number and adjust at least one of the sourcing rate, the screening rate and the selection rate to minimize a combination of costs of said sourcing rate, screening rate and selection rate with a cost of acquiring resources to satisfy the gap number that is determined as a function of the re-forecast demand number, and enter another set of a selected number of resources that meet the specified technical requirement into the selected pool for presentment of offers for acquisition as a function of the re-forecast demand number and the at least one adjusted sourcing rate, screening rate and selection rate.

16. The computer program product of claim 15, wherein the computer readable program code instructions for execution by the processor further cause the processor to enter the selected number of resources that meet the specified technical requirement into the selected pool by:
entering a first number of the resources into a resource pool at the sourcing rate that is variable over time during a first time period span that is inclusive of the demand forecast time period;
moving a second number of the resources that satisfy screening requirements from the resource pool into a screened pool at the screening rate that is variable over time during a second time period span that is subsequent to the first time period and inclusive of the demand forecast time period; and
moving a third number of the resources that satisfy selection requirements from the screened pool into a selected pool at the selection rate that is variable over time during a third time period span that is subsequent to the second time period and inclusive of the demand forecast time period.

17. The computer program product of claim 16, wherein the computer readable program code instructions for execution by the processor further cause the processor to forecast and re-forecast the demand number by using a Brownian motion model with drift to generate random values that quantify variability in demand for resources that meet the specified technical requirement in a continuous-time stochastic process as a function of a drift rate of change in average values of the generated random values.

18. The computer program product of claim 16, wherein the computer readable program code instructions for execution by the processor further cause the processor to revise the forecast and re-forecast demand numbers from the demand inputs for respective time periods of each of processes of the entry of the selected number of resources into the selected pool, the iterative offers for acquisition for each of the sequence of different offer time periods, the adjustment of the at least one of the sourcing rate, the screening rate and the selection rate and entry of the another set of selected number of resources that satisfy requirements for the specified skill set into the selected pool for presentment of acquisition offers as a function of the re-forecast demand number and the at least one adjusted sourcing rate, screening rate and selection rate.

19. The computer program product of claim 16, wherein the plurality of different awaiting offer buffers are each associated with different, respective rates of rejection for pending offers presented to the resources while they are in the respective buffers, and that are determined differentially by the processor as a function of market parameters and the different times during which the resources reside in respective ones of the different awaiting offer buffers.

20. The computer program product of claim 19, wherein the plurality of different awaiting offer buffers comprises a first awaiting offer buffer that is associated with a first of the different, respective rates of rejection for pending offers presented to the resources, a second awaiting offer buffer that is associated with a second of the different, respective rates of rejection for pending offers presented to the resources and that receives resources moved by the processor from the first awaiting offer buffer that have not rejected or accepted an offer for acquisition, and a third awaiting offer buffer that is associated with a third of the different, respective rates of rejection for pending offers presented to the resources and that receives resources moved by the processor from the second awaiting offer buffer that have not rejected or accepted an offer for acquisition; and
wherein the first rejection rate is less than the second rejection rate, and the second rejection rate is less than the third rejection rate.
